(19) United States
(12) Patent Application Publication
(10) Pub. No.: US 2003/0122978 A1
(43) Pub. Date: Jul. 3, 2003

(54) Liquid crystal display device having single bodied compensating pattern and method of fabricating the same

(76) Inventor: Joo Soo Lim, Kyongsongbuk-do (KR)

Correspondence Address: MORGAN LEWIS & BOCKIUS LLP, 1111 PENNSYLVANIA AVENUE NW, WASHINGTON, DC, 20004, US

(21) Appl. No.: 10/294,717

(22) Filed: Nov. 15, 2002

(30) Foreign Application Priority Data
Dec. 29, 2001 (KR) P2001-087763

(51) Int. Cl. G02F 1/136

(52) U.S. Cl. 349/42

(57) ABSTRACT

A liquid crystal display device having a single bodied compensating pattern and a method of fabricating the same are disclosed in the present invention. The liquid crystal display device includes first and second substrates, a metal layer on the first substrate, a passivation layer over the first substrate, the passivation layer having a contact hole to expose a portion of the conductive pad, a sealant over the first substrate, a single bodied compensating pattern between the sealant and the metal layer, a conductive dot connecting the compensating pattern and a common electrode of the second substrate, and a liquid crystal layer between the first and second substrates.

This application claims the benefit of the Korean Patent Application No. P2001-087763 filed on Dec. 29, 2001, which is hereby incorporated by reference.

### BACKGROUND OF THE INVENTION

1. Field of the Invention

The present invention relates to a liquid crystal display, and more particularly, to a liquid crystal display device having a single bodied compensating pattern and a method of fabricating the same. Although the present invention is suitable for a wide scope of applications, it is particularly suitable for preventing a black matrix from electrolytic corrosion in an etching process.

2. Discussion of the Related Art

As information technologies develop, various displays are in demand. Recently, many efforts have been made to research and develop various flat display panels such as a liquid crystal display device (LCD), a plasma display panel (PDP), an electroluminescent display (ELD), a vacuum fluorescent display (VFD), and the like. And, some types of the flat display panels have already been applied to various display devices.

An LCD is most widely used because of its characteristics and/or advantages of high quality images, light weight, thin and compact size, and low power consumption so as to be used as a substitution of cathode ray tube (CRT) for a mobile image display device. An LCD has also been developed so as to be applicable to such devices receiving broadcasting signals to display as a television, a computer monitor, and the like.

Even if there are significant developments in the LCD technology for an image display in various fields, the image quality fails to meet the characteristics and advantages of an LCD.

In order to apply a liquid crystal display device as a display device in various fields, development of an LCD depends on realizing high image qualities, such as high resolution, high brightness, wide screen, and the like, as well as maintaining characteristics of lightness, compactness, and low power consumption.

Such a liquid crystal display device includes a liquid crystal display panel displaying an image and a driving unit for applying driving signals to the liquid crystal panel. The liquid crystal display panel includes first and second substrates bonded to each other so as to secure a space therebetween and a liquid crystal layer injected between the first and second substrates.

In this case, on the first glass substrate (TFT array substrate), a plurality of gate lines are formed to be arranged in one direction to provide an interval from one another, a plurality of data lines arranged in a direction vertical to the gate lines to provide an interval from one another, a plurality of pixel electrodes formed in a matrix in pixel areas defined by the gate and data lines crossing one another, and a plurality of thin film transistors switched by signals of the gate lines to transfer signals of the data lines to the pixel electrodes.

On the second glass substrate (color filter substrate), a black matrix layer for shielding light from a portion except for the pixel areas, an R/G/B color filter layer for realizing colors, and a common electrode for realizing an image are formed. The common electrode is formed on the first substrate in a horizontal electric field type LCD.

The above-described first and second substrates are separated from each other by spacers to provide a space, and are bonded to each other through a sealant having a liquid crystal injection inlet. Further, liquid crystals are injected between the two substrates.

A process of fabricating a liquid crystal cell requires a liquid crystal display panel including a first substrate having thin film transistors formed thereon, a second substrate having a color filter layer formed thereon, and liquid crystals injected between the first and second substrates confronting each other to provide an interval from one another. And, a method of fabricating the above-described liquid crystal display panel is carried out by either ‘liquid crystal injection’ or ‘liquid crystal dropping’.

A related art liquid crystal display device is explained by referring to the attached drawings as follows.

FIG. 1A illustrates a layout of a liquid crystal display device fabricated by a conventional liquid crystal injection method.

Referring to FIG. 1A, a liquid crystal display device includes a lower substrate 19 having thin film transistors and pixel electrodes formed thereon, an upper substrate 18 on which a black matrix, a color filter layer, and a common electrode are formed, and a liquid crystal layer (not shown) formed between the upper and lower substrates 18 and 19.

A spacer (not shown) is dispersed on the lower substrate 19 to maintain a cell gap with the upper substrate 18, and a sealant having a liquid crystal injection inlet 10 is formed at the circumference of the lower substrate 19 to protect the liquid crystals as well as to bond the upper and lower substrates 18 and 19 to each other.

Meanwhile, the liquid crystal injection inlet 10 is formed at a side portion of the sealant 14, whereby the liquid crystals are injected through the liquid crystal injection inlet 10.

In the above-described liquid crystal display device, after the upper and lower substrates 18 and 19 have been bonded to each other, the liquid crystals are injected between the upper and lower substrates 18 and 19 by vacuum injection. The liquid crystals are injected through the liquid crystal injection inlet 10 by utilizing a difference between internal and external pressures of the liquid crystal panel.

FIG. 1B illustrates a layout of a liquid crystal display device fabricated by a liquid crystal dropping process.

Referring to FIG. 1B, a liquid crystal display device includes a lower substrate 19 having thin film transistors and pixel electrodes formed thereon, an upper substrate 18 on which a black matrix, a color filter layer, and a common electrode are formed, and a liquid crystal layer (not shown) formed between the upper and lower substrates 18 and 19.

In the method of liquid crystal dropping, a sealant is formed at the circumference of the upper substrate 18 or the lower substrate 19 without a liquid crystal injection inlet and a spacer (not shown) is dispersed on the lower substrate 19 so as to maintain a cell gap.

In the process of the above-described liquid crystal display device, after liquid crystals are dropped precisely and safely on the lower substrate 19 having the sealant 14 formed thereon by the previously calculated method, the upper and lower substrates 18 and 19 are bonded to each other.

FIG. 2 illustrates a layout of the magnified portion of “a” in FIGS. 1A and 1B in the related art liquid crystal display device. FIG. 3 illustrates a cross-sectional view of a liquid crystal display device taken along line III-III in FIG. 2. And, FIG. 4 illustrates a cross-sectional view of a liquid crystal display device taken along line IV-IV in FIG. 2.

Referring to FIGS. 2 to 4, a black matrix 31 preventing light leakage, an R/G/B color filter layer 32 realizing colors, and a common electrode 33 of a transparent conductive layer are formed on an upper substrate 18. And, gate and data lines vertically crossing each other to define a pixel, a thin film transistor 21 at each intersection between the gate and data lines, and a pixel electrode 22 electrically connected to a drain electrode of the thin film transistor 21 are formed on a lower substrate 19.

The thin film transistor 21 is formed of stacked layers including a gate electrode, a gate insulating layer, a semiconductor layer, and source and drain electrodes. The gate insulating layer 12 is formed between the gate and data lines, and a passivation layer 28 is formed between the data line and the pixel electrode 22.

In this case, a sealant 14 is formed at the circumference of the lower substrate 19 to provide a cell gap as well as to prevent leakage of liquid crystals. And, the sealant 14 is not formed at the portion for a liquid crystal injection inlet (i.e., the numeral 10 in FIG. 1), so that the liquid crystals can be injected later through the portion.

Meanwhile, the sealant 14 is formed on the passivation layer 28 of an organic insulating layer having weak adhesion. Since the adhesion between the sealant 14 and the passivation layer 28 is poor, the sealant 14 may fall apart or burst in injecting liquid crystals.

In order to resolve such a problem, the passivation layer 28 and the gate insulating layer 12 under the sealant 14 are selectively removed, so that the sealant 14 is contacted with a lower metal layer through a contact hole 23 to improve adhesion. The lower metal layer is a gate pad 11 extending from the gate line or a data pad (not shown) extending from the data line.

As the lower metal layer is exposed through the contact hole 23, a compensating pattern is formed on a portion including the contact hole 23 so as to avoid corrosion of the lower metal layer in etching the pixel electrode.

In addition, the compensating pattern embedded on the gate or data pad minimizes the resistance generated from the contact between the pad and the external driving circuit.

The compensating pattern is simultaneously formed with the pixel electrode formed of indium tin oxide (ITO) to have a separate pattern.

Namely, the compensating pattern, as shown in FIG. 2, is separated into a first compensating pattern 22a and a second compensating pattern 22b.

The first compensating pattern 22a is formed over the gate pad, while the second compensating pattern 22b is formed over the data pad across a portion where a silver (Ag) dot 30 is formed.

In this case, the silver (Ag) dot 30 connects the pixel electrode 22 of ITO on the lower substrate 19 to the common electrode 33 of ITO on the upper substrate 18 to flow electric charges of the lower substrate 19 into the upper substrate 18, so that the upper and lower substrates 18 and 19 become equipotential to each other. However, since the first compensating pattern 22a is separated from the second compensating pattern 22b connected to the silver (Ag) dot 30, the electric charges of the second compensating pattern 22b cannot flow into the upper substrate and remain thereon.

Namely, since the electric charges of the second compensating pattern 22b connected to the silver (Ag) dot 30 flow into the common electrode 33, the second compensating pattern 22b and the upper substrate 18 are always equipotential to each other. However, the first compensating pattern 22a is not connected to the common electrode 33, so that the electric charges cannot flow into the common electrode 33 and remain thereon. Hence, a potential difference occurs between the upper and lower substrates 18 and 19.

In case that water comes into contact between the upper and lower substrates 18 and 19, the potential difference between the upper and lower substrates 18 and 19 causes a water droplet (i.e., humidity) 50 to penetrate toward the black matrix 31 through the pin hole 51 of the common electrode 33, thereby causing electrolytic corrosion of the black matrix 31 (cf., FIG. 2). Such a phenomenon prevails particularly under the conditions of high temperature and humidity, thereby reducing a reliability of the device.

### SUMMARY OF THE INVENTION

Accordingly, the present invention is directed to a liquid crystal display device having a single bodied compensating pattern that substantially obviates one or more of problems due to limitations and disadvantages of the related art.

Another object of the present invention is to provide a liquid crystal display device having a single bodied compensating pattern that prevents electrolytic corrosion of a black matrix by making upper and lower substrates equipotential to each other.

Additional features and advantages of the invention will be set forth in the description which follows and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a liquid crystal display device includes first and second substrates, a metal layer on the first substrate, a passivation layer over the first substrate, the passivation layer having a contact hole to expose a portion of the conductive pad, a sealant over the first substrate, a single bodied compensating pattern between the sealant and the metal layer, a conductive dot connecting the compensating pattern and a common electrode of the second substrate, and a liquid crystal layer between the first and second substrates.

Namely, the present invention is characterized in that the first and second substrates are made equipotential to each other to prevent electrolyte corrosion of a black matrix by building the compensating pattern of ITO, which is embedded between the sealant and the metal layer as a single body, thereby preventing electric charges remaining on the first substrate.

In another aspect of the present invention, a method of fabricating a liquid crystal device includes forming first and second substrates, forming a metal layer on the first substrate, forming a passivation layer over the first substrate, the passivation layer having a contact hole to expose a portion of the conductive pad, forming a sealant over the first substrate, forming a single bodied compensating pattern between the sealant and the metal layer, forming a conductive dot connecting the compensating pattern and a common electrode of the second substrate, and forming a liquid crystal layer between the first and second substrates.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

In the drawings:

FIG. 1A illustrates a layout of a related art liquid crystal display device fabricated by a liquid crystal injection method;

FIG. 1B illustrates a layout of a related art liquid crystal display device fabricated by a liquid crystal dropping method;

FIG. 2 illustrates a layout of the magnified portion of “a” in FIGS. 1A and 1B in the related art liquid crystal display device;

FIG. 3 illustrates a cross-sectional view of the liquid crystal display device taken along line III-III in FIG. 2;

FIG. 4 illustrates a cross-sectional view of the liquid crystal display device taken along line IV-IV in FIG. 2;

FIG. 5 illustrates a layout of a liquid crystal display device according to the present invention; and

FIG. 6 illustrates a cross-sectional view of a liquid crystal display device taken along line VI-VI in FIG. 5.

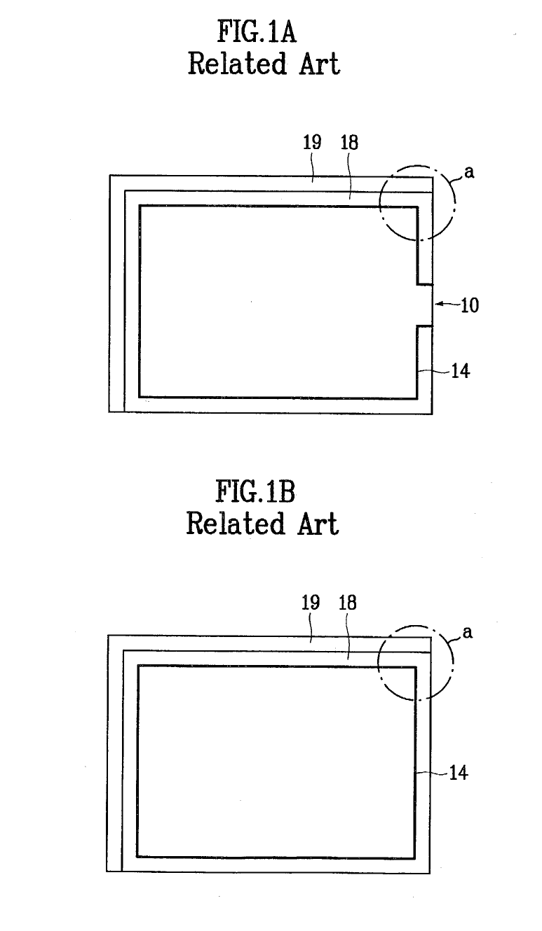

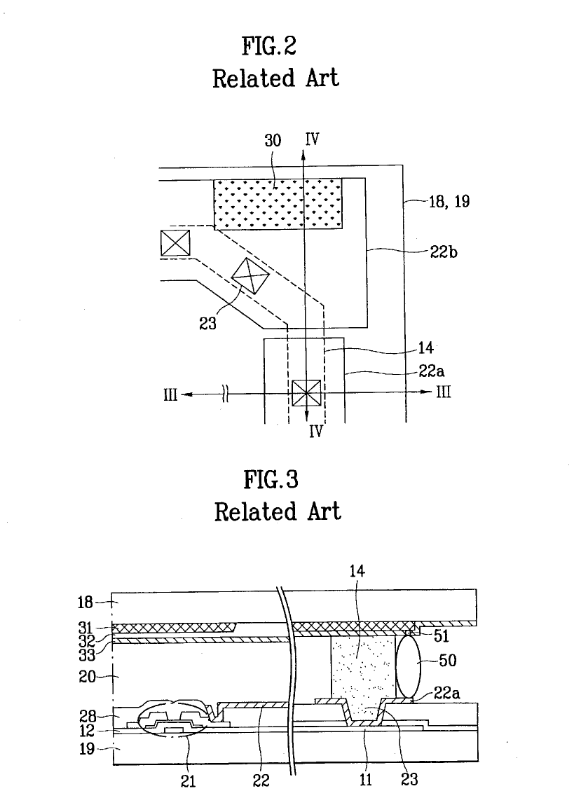

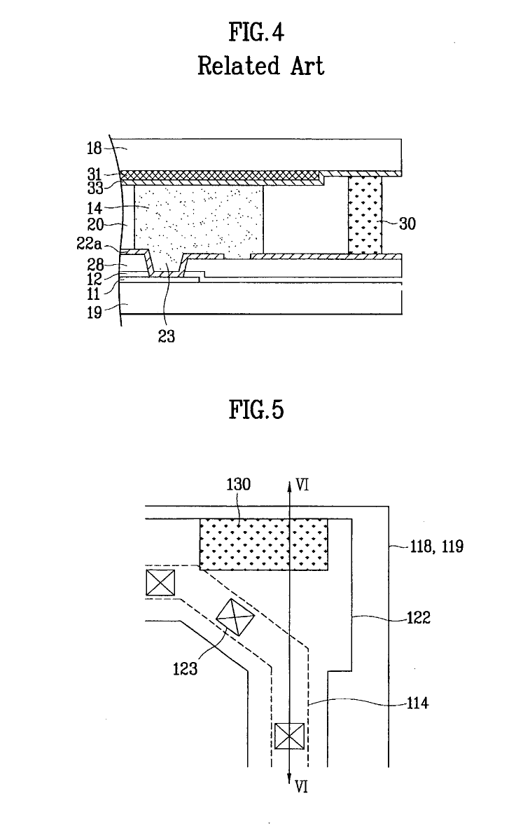

### DETAILED DESCRIPTION OF THE ILLUSTRATED EMBODIMENTS

Reference will now be made in detail to the illustrated embodiments of the present invention, examples of which are illustrated in the accompanying drawings. Wherever possible, the same reference numbers will be used throughout the drawings to refer to the same or like parts.

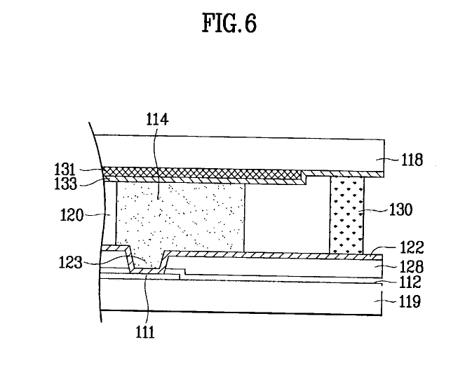

FIG. 5 illustrates a layout of a liquid crystal display device according to the present invention, while FIG. 6 illustrates a cross-sectional view of a liquid crystal display device taken along line VI-VI in FIG. 5.

Referring to FIGS. 5 and 6, a liquid crystal display device according to the present invention includes an upper substrate 118 having a black matrix 131 preventing light leakage, a color filter layer (not shown) of red/green/blue(R/G/B), and a common electrode 133 formed of ITO thereon, a lower substrate 119 having gate and data lines crossing each other to define a pixel area, a thin film transistor arranged in the pixel electrode, a pixel electrode formed of ITO arranged in the pixel area, and a passivation layer 128 formed between the thin film transistor and the pixel electrode, a sealant 114 formed on the circumference of the lower substrate 119 to bond the upper and lower substrates 118 and 119 to each other, and a liquid crystal layer 120 formed between the upper and lower substrates 118 and 119.

In order to improve adhesion to the sealant 114, the passivation layer 128 and the gate insulating layer 112 are selectively removed to form a contact hole 123 exposing a metal layer such as a gate pad 111, a data pad, or the like. For example, the passivation layer 128 may be formed of an organic insulating layer such as BCB, photo-acrylate, or the like.

In this case, the metal layer, such as the gate pad 111, the data pad, or the like, may be corroded since it is exposed through the contact hole 123 when the pixel electrode is etched. In order to prevent such corrosion, a compensating pattern 122 formed of ITO is further formed between the sealant 114 and the gate pad 111.

The compensating pattern 122 is simultaneously formed when the pixel electrode is formed in the active area and embedded between the gate pad 111 and the sealant 114 in the contact hole 123 formed by selectively removing the passivation layer 128 and the gate insulating layer 112. The metal layer becomes the gate pad extending from the gate line or the data pad extending from the data line.

The liquid crystal display device according to the present invention is characterized in that the compensating pattern 122 of the gate pad part 111 is formed in a single body with the compensating pattern 122 of the data pad part to be electrically conductive.

And, a silver (Ag) dot 130 is formed at one side of the compensating pattern 122 to connect the upper and lower substrates 118 and 119 to each other, whereby electric charges remaining on the lower substrate 119 quickly flow in the upper substrate 118 to make the upper and lower substrates 118 and 119 equipotential to each other.

In the related art, electric charges remain on the compensating pattern 122, which is not connected to the silver (Ag) dot 130, thereby causing a potential difference between the upper and lower substrates 118 and 119. Unlike the related art, the present invention makes the upper and lower substrates 118 and 119 equipotential to each other without generating a potential difference since all the electric charges flow in the upper substrate 118 through the silver (Ag) dot 130.

In this case, the electric charges on the lower substrate 119 flow into the common electrode 133 as a ground through the silver (Ag) dot 130, and then discharged to the outside to drive the common electrode 133 by alternating current (AC).

When the upper and lower substrates 118 and 119 become equipotential by forming the single bodied compensating pattern 122 and the compensating pattern 122 is connected to the silver (Ag) dot 130, the problem of corrosion of the black matrix 131 is resolved even when water penetrates between the upper and lower substrates 118 and 119 at high temperature and humidity.

Accordingly, the liquid crystal display device according to the present invention has the following advantages or effects.

First of all, the compensating pattern embedded between the sealant and the metal layer (gate or data pad) is formed in one body connected to the silver (Ag) dot. Thus, the entire electric charges, which remain on the lower substrate in the related art, flow in the upper substrate, thereby making the upper and lower substrates equipotential.

Therefore, the black matrix is protected from the corrosion even when water penetrates between the upper and lower substrates. In addition, the present invention provides the liquid crystal display device having high reliability under the conditions of high temperature and humidity.

It will be apparent to those skilled in the art that various modifications and variations can be made in the liquid crystal display device having a single bodied compensating pattern and the method of fabricating the same of the present invention without departing from the spirit or scope of the inventions. Thus, it is intended that the present invention covers the modifications and variations of this invention provided they come within the scope of the appended claims and their equivalents.

What is claimed is:

1. A liquid crystal display device, comprising:
first and second substrates;
a metal layer on the first substrate;
a passivation layer over the first substrate, the passivation layer having a contact hole to expose a portion of the conductive pad;
a sealant over the first substrate;
a single bodied compensating pattern between the sealant and the metal layer;
a conductive dot connecting the compensating pattern and a common electrode of the second substrate; and
a liquid crystal layer between the first and second substrates.

2. The device of claim 1, further comprising a plurality of thin film transistors on the first substrate and a plurality of pixel electrodes connected to the thin film transistors.

3. The device of claim 2, wherein the compensating pattern is simultaneously formed with the pixel electrodes.

4. The device of claim 1, wherein the compensating pattern is formed on the passivation layer and in the contact hole.

5. The device of claim 1, wherein the passivation layer includes an organic insulating layer.

6. The device of claim 5, wherein the organic insulating layer includes one of BCB and photo-acrylate.

7. The device of claim 1, wherein the compensating pattern is formed of ITO.

8. The device of claim 1, wherein the metal layer includes one of a gate pad and a data pad.

9. The device of claim 1, wherein the conductive dot is formed of silver (Ag).

10. The device of claim 1, further comprising:
a black matrix on the second substrate;
a color filter layer on the black matrix; and
a common electrode on the color filter layer.

11. A method of forming a liquid crystal display device, comprising:
forming first and second substrates;
forming a metal layer on the first substrate;
forming a passivation layer over the first substrate, the passivation layer having a contact hole to expose a portion of the conductive pad;
forming a sealant over the first substrate;
forming a single bodied compensating pattern between the sealant and the metal layer;
forming a conductive dot connecting the compensating pattern and a common electrode of the second substrate; and
forming a liquid crystal layer between the first and second substrates.

12. The method of claim 11, further comprising a plurality of thin film transistors on the first substrate and a plurality of pixel electrodes connected to the thin film transistors.

13. The method of claim 12, wherein the compensating pattern is simultaneously formed with the pixel electrodes.

14. The method of claim 11, wherein the compensating pattern is formed on the passivation layer and in the contact hole.

15. The method of claim 11, wherein the passivation layer includes an organic insulating layer.

16. The method of claim 15, wherein the organic insulating layer includes one of BCB and photo-acrylate.

17. The method of claim 11, wherein the compensating pattern is formed of ITO.

18. The method of claim 11, wherein the metal layer includes one of a gate pad and a data pad.

19. The method of claim 11, wherein the conductive dot is formed of silver (Ag).

20. The method of claim 11, further comprising:
forming a black matrix on the second substrate;
forming a color filter layer on the black matrix; and
forming a common electrode on the color filter layer.
